(19) United States
(12) Patent Application Publication
(10) Pub. No.: US 2008/0041251 A1
(43) Pub. Date: Feb. 21, 2008

(54) PRINTING PRESS

(75) Inventors: Peer Dilling, Friedberg (DE); Josef Goettling, Friedberg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/781,790

(22) Filed: Jul. 23, 2007

(30) Foreign Application Priority Data
Jul. 24, 2006 (DE) 10 2006 034 661.0

(51) Int. Cl. B41F 13/02

(52) U.S. Cl. 101/219

(57) ABSTRACT

A printing press and a method for operating the printing press is disclosed. The press has at least one printing unit including at least one printing couple with a transfer cylinder, a form cylinder carrying an imageable and de-imageable printing form, an inking couple and a dampening unit. A memory is assigned inside the printing press to at least one printing unit having several memory locations for form cylinders, where the form cylinders for the printing units can be transferred automatically by at least one transport device between a printing couple of the printing unit and a memory location of the memory, where the form cylinders can be transferred automatically inside the memory between the various memory locations, and where an imaging device is assigned to at least one memory location to image and de-image in advance an imageable and de-imageable printing form positioned on a form cylinder.

This application claims the priority of German Patent Document No. 10 2006 034 661.0, filed Jul. 24, 2006, the disclosure of which is expressly incorporated by reference herein.

### BACKGROUND AND SUMMARY OF THE INVENTION

The invention relates to a printing press. The invention further relates to a method for operating such a printing press.

When printing with a solid printing form, a principle distinction is made between printing processes which operate either using one-time writeable or using rewriteable printing forms. Printing processes which use rewriteable printing forms are grouped under the rubric “computer to press/direct imaging.” The applicant markets printing presses under the product name “DICOweb” which operate with rewriteable and erasable printing forms. The basic features of DICOweb technology are described in the “Manual of Print Media,” Helmut Kipphan, pages 674 to 680, 2000, Springer Verlag.

In printing presses known from practice, the printing forms located on the form cylinders of the printing units are imaged either simultaneously or parallel to the printing process outside the printing press, or as with DICOweb technology, sequential to the printing process inside the printing press. Performing imaging inside the printing press which involves interrupting the printing process brings the disadvantage that the printing press is not available for production during the imaging. Imaging of the printing forms located on the form cylinders outside the printing press during the printing process brings the disadvantage that the printing forms have to be removed from the printing units of the press by means of expensive manual intervention, which ultimately requires extensive use of personnel.

With this as the starting point, the object of the present invention is to create a novel printing press.

In accordance with the invention, a memory having several memory locations for form cylinders is assigned within the printing press to at least one printing unit where the form cylinders of the, or each, printing unit can be transferred automatically by way of least one transport device between a print couple of the printing unit and a memory location in the memory, where the form cylinders within the storage device can be transferred automatically between the various memory locations of the memory and where an imaging device is assigned at least to one memory location of the memory to image an imageable and de-imageable printing form positioned on a form cylinder, and if necessary, to de-image it beforehand.

In the sense of the present invention, imageable and de-imageable printing forms can be imaged simultaneously with, or parallel to, the printing process, but inside the printing press. Printing forms along with the specific form cylinder are removed automatically from the print couples of the printing unit with the aid of a transport device and taken to an appropriate memory which is positioned inside the printing press and has several memory locations for form cylinders. An imaging device is assigned to at least one memory location of the memory to image the printing forms automatically inside the storage device and to de-image them if necessary. In a memory location of the memory, a form cylinder with an already imaged printing form is kept ready as a replacement for the form cylinder removed from a printing couple so that immediately following the removal of one form cylinder from a printing couple of a printing unit of the press, a form cylinder with an imaged printing form can be placed in the appropriate printing couple.

The down time of the press is thus limited to the changeover time for the form cylinder so that the press is available almost uninterruptedly for the printing process. The de-imaging and imaging of a printing form taken from a printing couple in the area of the memory location of the memory to which an imaging device is assigned takes place parallel to the printing process.

Preferred further developments of the invention can be found in the subsequent description. Embodiments of the invention are explained using the drawings, without being restricted thereto.

### BRIEF DESCRIPTION OF THE DRAWINGS

FIG. 1 shows a schematized section from a web rotary press in accordance with the invention; and

FIG. 2 shows a schematized section from a sheet-fed press in accordance with the invention.

### DETAILED DESCRIPTION OF THE DRAWINGS

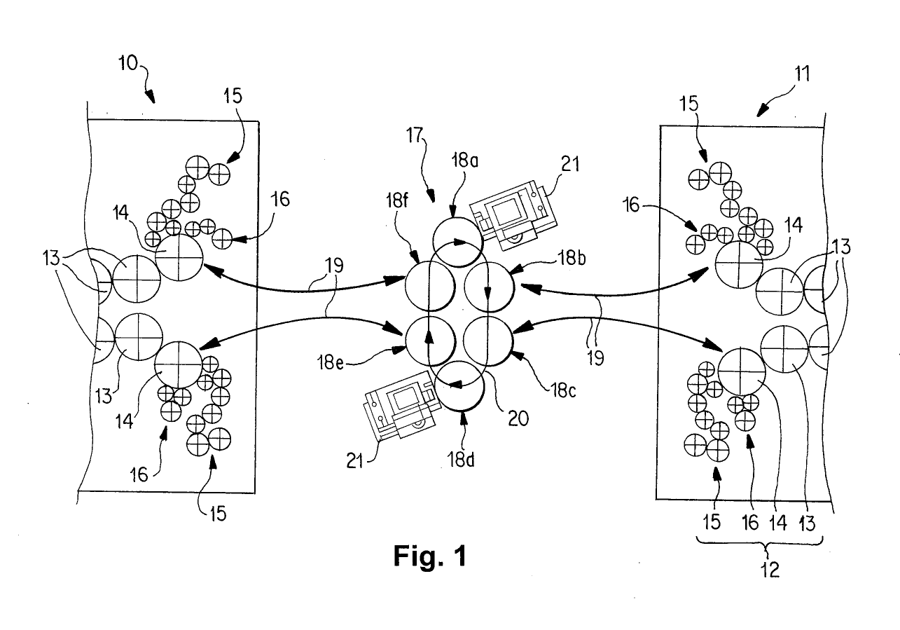

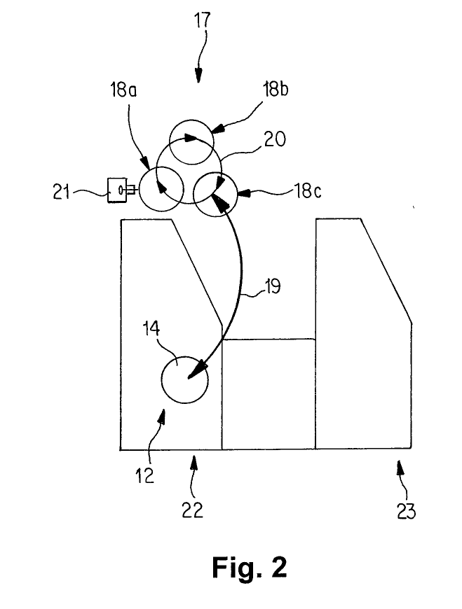

In what follows, the present invention will be described in greater detail with reference to FIGS. 1 and 2, where FIG. 1 describes the invention using the example of a web rotary press and FIG. 2 the example of a sheet-fed press.

FIG. 1 shows a section from a web rotary press in the area of two adjacent printing units 10, 11 where the printing units 10, 11 shown in section in FIG. 1 are configured as H-printing units each having four printing couples 12.

Each of the printing couples comprises a transfer cylinder 13, a form cylinder 14, an inking couple 15 and a dampening unit 16, where the form cylinders 14 carry imageable and de-imageable printing forms. These printing forms can be either printing sleeves or printing plates, where the use of printing sleeves is preferred in continuous stationery printing.

In accordance with FIG. 1 a memory 17 is assigned to the two presses 10, 11 inside the web rotary press which comprises several memory locations 18a, 18b, 18c, 18d, 18e and 18f for form cylinder 14. In the sense of the invention, with the aid of a transport device not shown, which can be configured for example as a pivoting arm, form cylinders 14 can be transferred between the printing couple 12 of the printing units 10, 11 and memory, or storage, locations of the storage unit 17. Thus, in accordance with FIG. 1 for the lower printing couple 12 shown of the printing unit 10, a form cylinder 14 can be transferred between this printing couple and the memory, or storage, location 18e. For the upper printing couple of the printing unit 11 shown in FIG. 1 on the other hand, the form cylinder 14 can be transferred between the printing couple 12 and the memory location 18b.

Inside the storage device the form cylinders 14 can be transferred between the various memory locations 18a to 18f, specifically in the embodiment from FIG. 1 in the direction visualized by arrow 20. Each form cylinder 14 can consequently be moved successively through the individual memory locations following transfer of the form cylinder to a memory location. The memory is consequently designed as a paternoster-style memory.

In the embodiment from FIG. 1, one imaging device 21 is assigned to each of two memory locations of the memory 17, specifically the memory locations 18a and 18d.

Printing forms which are located on form cylinders 14 transferred to the memory locations are consequently automatically imageable and erasable in the area of these memory locations with the aid of the imaging device.

From the arrangements described above, it follows that a principal distinction can be made between two different types of memory locations in the memory 17, namely between the interim memory locations 18a and 18d in which imaging of printing forms located on form cylinders can take place, and the memory locations 18b, 18c, 18e and 18f which serve to receive or keep in readiness form cylinders to be transferred between the memory 17 and printing couples 12. The memory locations 18a and 18d can thus also be described as set-up locations and the memory locations 18b, 18c, 18e and 18f as transfer locations.

As already mentioned, the form cylinders 14 along with the printing forms positioned on the same are transferred between the printing couples 12 of the printing units 10, 11 and the memory 17 on the press in accordance with the invention. The printing forms located on the form cylinders 14 can be configured as printing sleeves or printing plates and be connected detachably to the appropriate form cylinders 14. It is likewise also possible that an outer surface of the form cylinders 14 provides the printing form directly and thus the printing form is connected non-detachably to the appropriate form cylinder.

Both in the area of the printing couples 12 and in the area of the memory locations 18a, 18d, or the set-up locations for the memory 17, bearing units are located to carry the form cylinders 14 in the area of the printing couples 12 in a impression-on position and in an imaging position in the area of the specific storage cells 18a, 18d. In the impression-on position in the area of the printing couples 12, as well as in the imaging position in the area of the memory locations 18a, 18d, the bearing units are closed to allow rotation of the particular form cylinders 14 for printing or imaging.

It follows that drives are assigned in the area of the memory locations 18a, 18d, or of the set-up locations for the memory 17, to set the form cylinders 14 for imaging inside the memory cells 18a, 18d in motion. A further drive for the memory 17 serves to transfer the form cylinders 14 inside the memory 17 in the direction of the arrow 20 between the various memory locations 18a to 18f when the bearing units are open.

In order to ensure easier transportation of the form cylinders 14 between the printing couples 12 of the printing units 10, 11 and the memory 17, the form cylinders 14 can be configured either as hollow cylinders or be produced from a composite material to achieve a reduction in weight. The transfer of the form cylinders 14 between the printing couples 12 and the memory 17 with the aid of transport devices is undertaken either on translatory motion paths or on curved motion paths.

If, for example, in the case of the press from FIG. 1 the printing form located on form cylinder 14 of the upper printing couple 12 of the printing unit 10 shown in FIG. 1 is exchanged for a new printing form, the procedure for converting this printing couple 12 is that form cylinder 14 is taken from the impression-on position to an impression-off position, where the inking couple and the dampening unit 16 are disengaged ahead of the form cylinder and the bearing units of the corresponding printing couple 12 for the form cylinder 14 are opened. Next, the form cylinder 14 is removed from the printing couple 12 and transferred to memory location 18f of the memory 17. Then the form cylinder 14 removed from the printing couple 12 is transferred from memory location 18f to the memory location 18a, where simultaneously a form cylinder 14 kept in readiness in the area of memory location 18e reaches memory location 18f. This form cylinder 14 carries an already imaged printing form which can be taken automatically to the upper printing couple 12 of the printing unit 10 shown in FIG. 1, starting from the memory 17.

This form cylinder 14 with the already imaged printing form is transferred to an impression-on position where the inking couple 15 and the dampening unit 16 are engaged to the form cylinder and the bearing units of the printing couple 12 for the printing cylinder 14 are closed. The printing form, which is positioned on the form cylinder 14 previously removed from the printing form 12 and taken to the memory cell 18a is de-imaged in the area of the memory location 18a with the aid of the imaging device 21 and then re-imaged, where the appropriate bearing units of the memory cell 18a are closed.

In the manner above, form cylinders 14 for several printing couples 12 as well as for several printing units 10, 11 can be exchanged simultaneously to re-equip the corresponding printing couples 12 of the printing units 10, 11.

The invention is not restricted to web rotary presses; the invention can also be used on a sheet-fed press, where FIG. 2 shows a section from a sheet-fed press in the area of two printing units 22, 23. In the case of a sheet-fed press, each printing unit 22, 23 has only one printing couple 12, for which unit only the form cylinder 14 is shown. In the embodiment in FIG. 2 a memory 17 is assigned to the printing unit 22 which is configured in principle like the memory 17 of the web rotary press from FIG. 1, for which reason the same reference numerals are used for the same subassemblies to avoid unnecessary repetition. In what follows only the details in which the embodiment in FIG. 2 differs from the embodiment in FIG. 1 will be discussed. The memory 17 from the embodiment in FIG. 2 comprises only three memory locations 18a, 18b and 18c, where an imaging device 21 is assigned to memory location 18a and where starting from memory location 18c form cylinders can be transferred between the memory 17 and the printing couple 12 of the printing unit 22.

The memory location 18a is in turn a set-up location and memory location 18c is a transfer location. In order to be able to provide a form cylinder with a newly imaged printing form to the printing couple 12 immediately after transferring a form cylinder 14 from the printing couple 12 to the memory location 18c, the memory 17 has, in addition to the already mentioned memory locations 18a and 18c, a third memory location 18b where the form cylinder 14 can in-turn be transferred in the direction of the arrow 20 between the individual memory locations 18a, 18b and 18c.

With a web rotary press, a memory 17 is preferably integrated in a support between two adjacent printing units 10, 11. With a sheet-fed press on the other hand, the memory 17 is preferably integrated into a superstructure above a printing unit.

Reference numeral list:

10 Printing unit

11 Printing unit

12 Printing couple

13 Transfer cylinder

14 Form cylinder

15 Inking couple

16 Dampening system

17 Memory/storage

18a Memory/storage location

18b Memory/storage location

18c Memory/storage location

18d Memory/storage location

18e Memory/storage location

18f Memory/storage location

19 Direction of movement

20 Direction of movement

21 Imaging device

22 Printing unit

23 Printing unit

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing press having a printing unit where the printing unit includes a printing couple with a transfer cylinder, a form cylinder with an imageable and de-imageable printing form, and an inking couple, wherein inside the printing press a memory having memory locations for form cylinders is assigned to the printing unit, wherein the form cylinder of the printing unit is transferable automatically by a transport device between the printing couple of the printing unit and a memory location of the memory, wherein a form cylinder inside the memory is transferable automatically between the memory locations, and wherein an imaging device is assigned to a memory location to image an imageable and de-imageable printing form positioned on a form cylinder.

2. The printing press according to claim 1, wherein the printing press is configured as a sheet-fed press.

3. The printing press according to claim 1, wherein the printing press is configured as a web rotary press and wherein the printing unit of the web rotary press includes two printing couples

4. The printing press according to claim 1, wherein the memory is assigned inside the printing press to two printing units.

5. The printing press according to claim 1, wherein in an area of the printing couple and in an area of the memory locations of the memory, bearing units are assigned, to which memory locations an imaging device is assigned, and wherein the bearing units carry the form cylinder in the printing couple in an impression-on position and in an imaging position in the memory locations of the memory.

6. The printing press according to claim 5, wherein for transferring form cylinders between the printing couple and a memory location of the memory, and for transferring the form cylinders between various memory locations of the memory, the respective bearing units are opened and thus release the respective form cylinders.

7. The printing press according to claim 1, wherein at least two drives are assigned to the memory, wherein a first drive transfers the form cylinders between the memory locations of the memory, and wherein a second drive drives the form cylinder in the memory location to which the imaging device is assigned.

8. The printing press according to claim 1, wherein the printing forms are configured as printing sleeves or printing plates and are connected detachably to a respective form cylinder.

9. The printing press according to claim 1, wherein the printing form is configured as part of an outer surface of the form cylinder and is connected non-detachably to the form cylinder.

10. The printing press according to claim 1, wherein the form cylinders are configured hollow.

11. The printing press according to claim 1, wherein the form cylinders are made from a composite material.

12. The printing press according to claim 1, wherein the form cylinders are moveable on a translatory path with aid of the transport device.

13. The printing press according to claim 1, wherein the form cylinders are moveable on a curved path with aid of the transport device.

14. A method for operating a printing press, comprising the steps of:
a) for converting a printing couple of a printing unit of the press, specifically to perform a printing image change on a form cylinder of the printing couple, the form cylinder in the printing couple is transferred to an impression-off position wherein the printing couple is disengaged from the form cylinder and bearing units of the form cylinder are opened;
b) then the form cylinder is removed from the printing couple and transferred to a first memory location of a memory unit assigned to the printing unit inside the printing press;
c) subsequently the form cylinder removed from the printing couple is transferred from the first memory location to a second memory location to which an imaging device is assigned where at a same time an imaged form cylinder is transferred to the first memory location;
d) then the imaged form cylinder transferred to the first memory location is removed from the first memory location and transferred to the printing couple;
e) then the form cylinder transferred to the printing couple of the printing unit is transferred to an impression-on position where the inking couple is engaged to the form cylinder and the bearing units of the form cylinder are closed; and
f) the printing form which is positioned on the form cylinder removed from the printing couple and transferred to the second memory location is de-imaged in an area of the second memory location and re-imaged.

15. A printing press, comprising:
a printing unit including a printing couple having a form cylinder with an imageable and de-imageable printing form; and
a memory having memory locations for form cylinders inside the printing press and assigned to the printing unit;
wherein the form cylinder is transferable by a transport device between the printing couple and a memory location of the memory;
wherein a form cylinder inside the memory is transferable between the memory locations; and
wherein an imaging device is assigned to a memory location to image the imageable and de-imageable printing form positioned on the form cylinder.

16. The printing press according to claim 15, further comprising a second printing unit including a second printing couple having a second form cylinder with a second imageable and de-imageable printing form;
wherein the second form cylinder is transferable by the transport device between the second printing couple and a memory location of the memory; and
wherein the imaging device images the second imageable and de-imageable printing form positioned on the second form cylinder.

17. The printing press according to claim 16, wherein the memory is disposed between the printing unit and the second printing unit.

18. A method for operating a printing press, comprising the steps of:
transferring a form cylinder of a printing unit to a first memory location of a memory unit assigned to the printing unit and disposed inside the printing press;
transferring the form cylinder from the first memory location to a second memory location;
transferring an imaged form cylinder to the first memory location; and
transferring the imaged form cylinder from the first memory location to the printing unit.

19. The method according to claim 18, further comprising the steps of de-imaging and re-imaging a printing form on the form cylinder at the second memory location.

20. The method according to claim 20, wherein the step of transferring the form cylinder from the first memory location to the second memory location and the step of transferring the imaged form cylinder to the first memory location occur at a same time.
